(19) United States
(12) Patent Application Publication
(10) Pub. No.: US 2024/0061389 A1
(43) Pub. Date: Feb. 22, 2024

(54) SERVO CONTROL DEVICE

(71) Applicant: FANUC CORPORATION, Yamanashi (JP)

(72) Inventors: Takashi OKAMOTO, Yamanashi (JP); Yuuki MORITA, Yamanashi (JP)

(73) Assignee: FANUC CORPORATION, Yamanashi (JP)

(21) Appl. No.: 18/259,754

(22) PCT Filed: Mar. 22, 2022
(86) PCT No.: PCT/JP2022/013298

§ 371 Date: Jun. 28, 2023

(30) Foreign Application Priority Data
Mar. 26, 2021 (JP) 2021-052695

(51) Int. Cl. G05B 19/04

(52) U.S. Cl. CPC G05B 19/041

(57) ABSTRACT

The objective of the present invention is to make it possible to also handle cases in a control device for a machine tool in which the waveform of a repeatable command superimposed on a normal movement command has a free shape that cannot be expressed only by a feature amount when obtaining a control command in which the repeatable command is superimposed on the normal movement command as a control command of the control device. The abovementioned objective is achieved by providing a servo control device with: a repeatable command creation unit that acquires the period of a repeatable command waveform and one period of command data from a higher-level control device, creates a repeatable command, and outputs the result; and a command superimposing unit that acquires a movement command from the higher-level control device and superimposes the repeatable command output by the repeatable command creation unit on the movement command.

### TECHNICAL FIELD

The present invention relates to a servo control device, and more particularly to a servo control device that performs motor control in accordance with a command including a repetitive oscillation command.

### BACKGROUND ART

Conventionally, in the control of a drive device such as a motor, a command prepared by superimposing a command in relation to repetitive movement such as a reciprocal vibration command (swing command) on a command having non-repeatability has been used as the control command.

Patent Document 1 describes a technique of controlling a machine tool that performs a threading process by performing a turning process on a workpiece, in which a swing movement is incorporated in a machining movement of a tool in order to thin chips generated by the turning process, and a control technique of the machine tool that adds (superimposes) a repetitive oscillation command relating to a swing movement with a swing amplitude and in a swing direction appropriate for cutting the chips to a movement command for relatively moving the workpiece and the tool for the turning process.

Patent Document 2 relates to a control device for a machine tool that performs swing cutting, and describes a control device for a machine tool that performs machining of a workpiece while relatively swinging a tool and a workpiece by cooperative movement of a spindle and a feed axis in order to finely cut chips generated by machining for the purpose of reducing a load on the machine tool due to swing cutting. This indicates that the command in relation to swinging a workpiece and a tool relatively is superimposed. Further, in the technology of Patent Document 2, when the machining condition indicates the machining by the interpolation movement of one of a plurality of feed axes, the tool and the workpiece are relatively swung in the direction along the machining path, and when the machining condition indicates machining by the simultaneous interpolation movement of the plurality of feed axes, the swing direction is changed or the swing is stopped with respect to the machining path.
Patent Document 1: Japanese Unexamined Patent Application, Publication No. 2019-185355
Patent Document 2: Japanese Unexamined Patent Application, Publication No. 2020-9248

### DISCLOSURE OF THE INVENTION

### Problems to be Solved by the Invention

As described above, a technique is known in which a control command in a control device of a machine tool includes a repetitive oscillation command such as a reciprocal vibration command (swing command, oscillation command, etc.) in a superimposed manner in addition to a command having non-repeatability.

However, in Patent Document 1, it is assumed that the waveform of the swing command is a sine wave or a triangular wave upon generating the swing command (repetitive oscillation command) in the control device (servo control device). However, unlike a waveform that can be grasped by only a characteristic amount such as a sine wave or a triangular wave, a swing command cannot be handled in the case of being a swing command in which the waveform assumes a complex shape and a free shape which cannot be expressed by only such a feature amount.

Furthermore, in Patent Document 2, a swing command (repetitive oscillation command) is generated by an upper control unit, and the generated swing command is transmitted to a control unit (servo control unit). However, a cosine wave waveform is assumed in Patent Document 2 and, therefore, a command of a waveform having a free shape which cannot be expressed only by a feature amount cannot be handled as well.

With the improvement in the production processing technology by a machine tool, etc., it is desired to further improve the machining accuracy and the machining efficiency, and it is expected in the future that a swing command superimposed on the basic machining command is required to have a waveform having a free shape which cannot be expressed by only a feature amount. In such a case, there is a technical problem in that it is difficult to deal with a device provided on the assumption that the swing command is a sine wave, a cosine wave, or a triangular wave, such as in Patent Document 1 or Patent Document 2.

It is an object of the present invention to provide a servo control device capable of dealing with a case of a control command in which a waveform of a repetitive oscillation command superimposed on a normal movement command has a free shape which cannot be expressed by only a feature amount when a control command obtained by superimposing the repetitive oscillation command on the normal movement command is obtained in a control device of a machine tool.

### Means for Solving the Problems

In order to solve the abovementioned problem, a servo control device for performing control of a servo motor is provided which includes: a repetitive oscillation command generator that obtains a cyclic period and command data for one period of a repetitive oscillation command waveform, and generates and outputs a repetitive oscillation command; and a command superimposer that obtains a movement command from the upper control device and superimposes the repetitive oscillation command outputted by the repetitive oscillation command generator on the movement command.

### Effects of the Invention

According to the servo control device of the present disclosure, when servo control is performed, it is possible to deal with a case of a control command in which a waveform of a repetitive oscillation command has a free shape which cannot be expressed by only a feature amount. Furthermore, it is possible to form a waveform of a superimposed command of a free shape by superimposing a repetitive oscillation command of a free shape which cannot be expressed by only a feature amount on a basic movement command, whereby it is possible to deal with a case where further improvement of machining accuracy and machining efficiency is required and finer handling is required.

### BRIEF DESCRIPTION OF THE DRAWINGS

FIG. 1 is a control block diagram of a servo control device according to an embodiment of the present disclosure;

FIG. 2 is a diagram illustrating a normal movement command and a repetitive oscillation command according to the present disclosure;

FIG. 3 is a diagram showing a repetitive oscillation command (high-frequency repetitive oscillation command);

FIG. 4 is a diagram showing a trapezoid command, which is an example of a command having non-repeatability;

FIG. 5 is a diagram showing a command including a linear acceleration/deceleration part and a constant speed part, which is an example of a command having non-repeatability;

FIG. 6 is a diagram showing a low-frequency repetitive oscillation command;

FIG. 7 is a diagram showing a period T1 in a repetitive oscillation command;

FIG. 8 is a diagram showing phase data corresponding to a repetitive oscillation command;

FIG. 9 is a diagram equivalent to phase data corresponding to a repetitive oscillation command;

FIG. 10 is a diagram showing phase data for each servo control period;

FIG. 11 is a diagram showing a repetitive oscillation command in an embodiment;

FIG. 12 is a diagram showing a method of generating command data for one period of a repetitive oscillation command in an embodiment; and

FIG. 13 is a flowchart showing an embodiment of the present disclosure.

### PREFERRED MODE FOR CARRYING OUT THE INVENTION

Hereinafter, embodiments of the present invention will be described in detail with reference to the accompanying drawings.

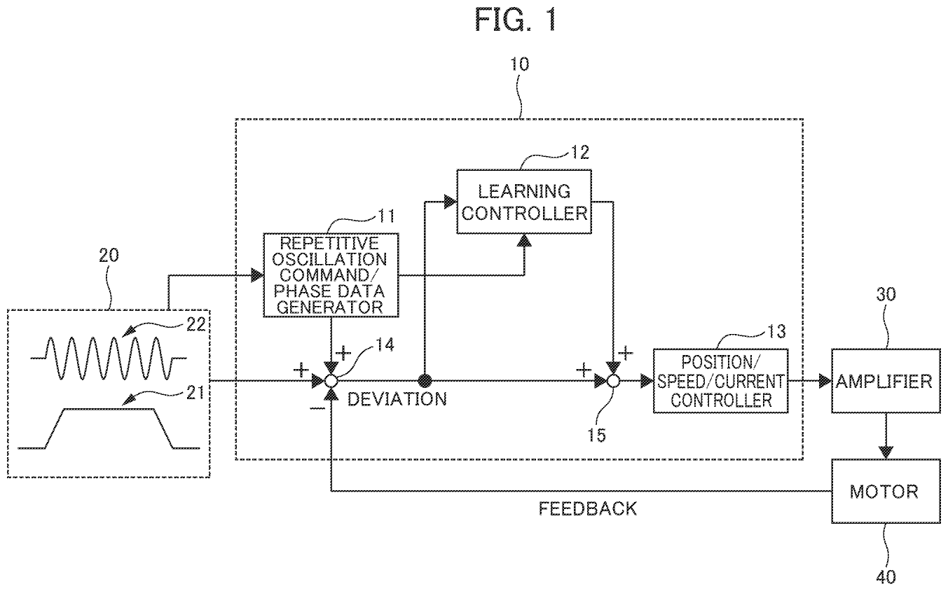

FIG. 1 is a control block diagram of a servo control device according to an embodiment of the present disclosure. As shown in FIG. 1, in the servo control device according to the embodiment of the present disclosure, data in relation to a movement command and a repetitive command (repetitive oscillation command) is notified from an upper control device 20 to a servo control device 10, the repetitive oscillation command and phase data are generated in the servo control device 10, the repetitive oscillation command is superimposed on the movement command, learning control based on the phase data is applied, and position, speed, and electric current control are applied, and then the data is sent to the amplifier 30, whereby the motor 40 is driven and controlled by the output.

The servo control device 10 includes a repetitive oscillation command/phase data generator 11, a learning controller 12, a position/speed/current controller 13, a first adder 14, and a second adder 15.

A signal of a normal movement command such as a command having non-repeatability is sent from the upper control device 20 to the first adder 14 of the servo control device 10, and data relating to the signal of the repetitive oscillation command is sent to the repetitive oscillation command/phase data generator 11. The normal movement command includes, for example, a command for basic design for determining the shape of a workpiece. The repetitive oscillation command/phase data generator 11 generates a repetitive oscillation command and sends it to the first adder, generates phase data for each servo period or cycle, and sends it to the learning controller 12. The abovementioned “data relating to a signal of a repetitive oscillation command”, “generation of phase data”, and “generation of a repetitive oscillation command” will be described in detail later. On the other hand, in the first adder 14, the repetitive oscillation command generated by the repetitive oscillation command/phase data generator 11 is added (superimposed) to the movement command sent from the upper control device 20 to form a superimposed command, and the deviation between the superimposed command and the signal fed back from the motor 40 is obtained and sent to each of the learning controller 12 and the second adder 15.

In the learning controller 12, learning control is performed on the deviation between the superposed command obtained by the first adder 14 and the feedback signal based on the phase data generated by the repetitive oscillation command/phase data generator 11. In learning control based on phase data, a compensation amount is obtained by an integrated deviation up to one period before, and an inputted command (deviation) is compensated to improve followability to a periodic command, and the technology itself is well known in the related art, and thus a detailed description thereof is omitted here. By applying the learning control, it is possible to perform operation with high followability and high-precision.

The second adder 15 adds the deviation between the command obtained by superimposing the movement command from the upper control device 20 calculated by the first adder 14 and the repetitive oscillation command from the repetitive oscillation command/phase data generator 11, and the signal fed back from the motor 40, and an output signal from the learning controller 12, whereby the output is sent to the position/speed/current controller 13. The position/speed/current controller 13 calculates an appropriate drive voltage of the motor 40 from the inputted position command, speed command, and current command, and drives the motor 40 by the output extended and adjusted by the amplifier 30.

The upper control device 20 outputs, to the servo control device 10, data related to a normal movement command 21 such as a command having non-repeatability and a repetitive oscillation command 22. In the present disclosure, as the “data relating to the repetitive oscillation command 22”, the cyclic period and the command data for one period of the repetitive oscillation command waveform are outputted from the upper control device 20 to the servo control device 10. Here, the reason why the command data for one period is outputted is that it is possible to deal with not only the conventional sine wave, triangular wave, and rectangular wave, but also with a command of a waveform having a free shape which cannot be expressed by only the feature amount.

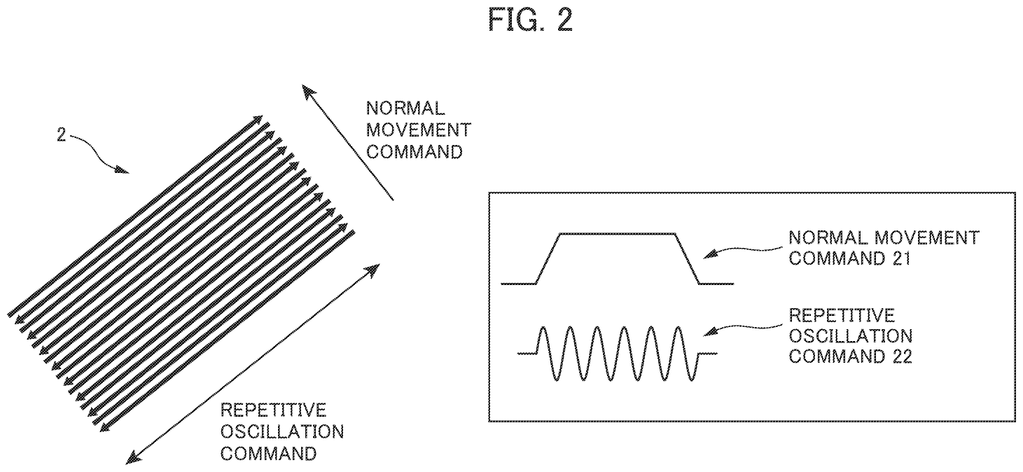

Next, with reference to FIG. 2, a normal movement command and a repetitive oscillation command will be described. On the left side of FIG. 2, an movement (raster movement) is depicted in which a normal movement command in a direction perpendicular to the direction of the reciprocating movement by the repetitive oscillation command is superimposed on the repetitive oscillation command, and the reciprocating movement is moved by a constant amount in the vertical direction for each period to fill up a certain area.

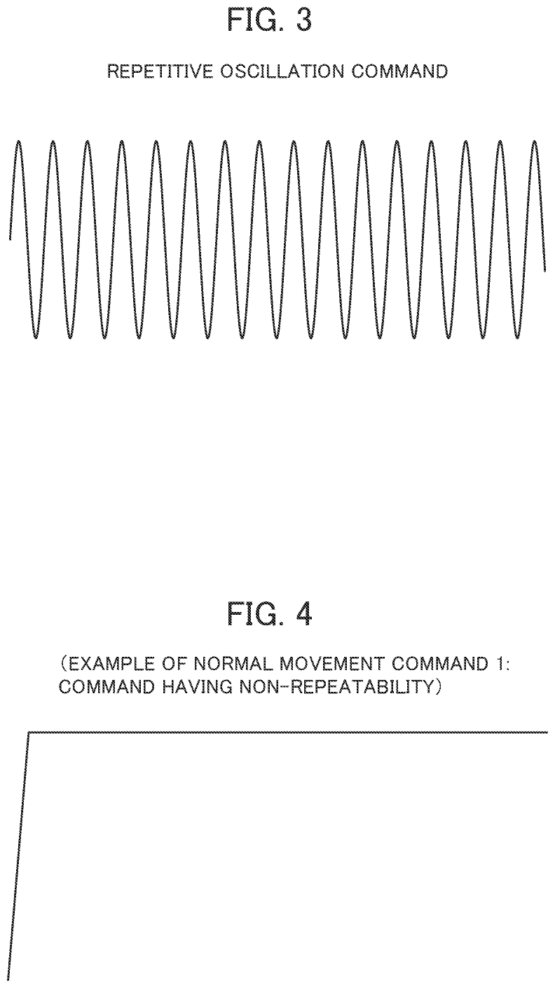

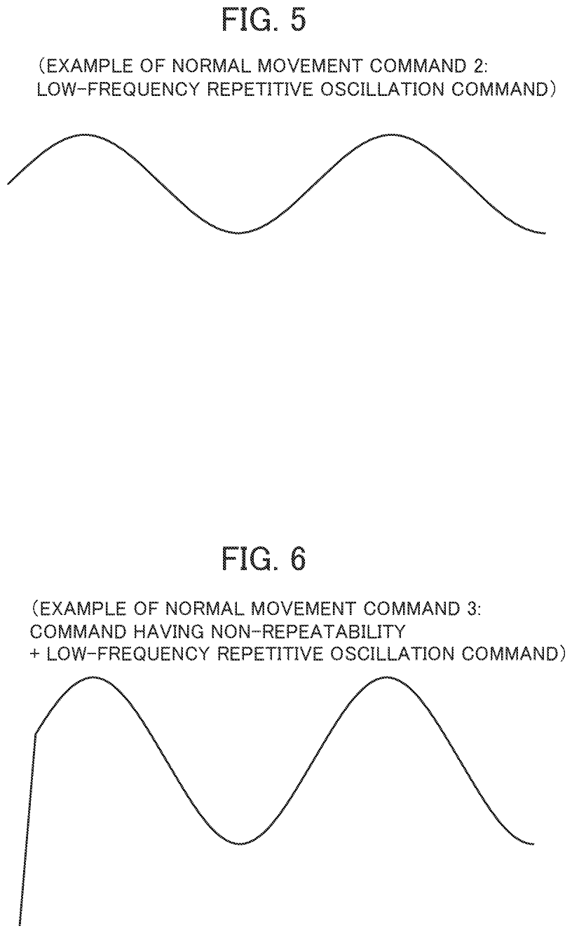

The repetitive oscillation command is a command for repeating a reciprocating movement, and examples thereof include a command of a waveform (a sine wave or the like) shown as a representative diagram on the right side of FIG. 2. Furthermore, FIG. 3 shows an example of a waveform of a high-frequency signal. The normal movement command corresponds to either a non-repetitive command, a low-frequency repetitive command, or a combination thereof. Examples of the non-repetitive command include a trapezoid command shown as a representative diagram on the right side of FIG. 2, and a command including a linear acceleration/deceleration part and a constant speed part shown as a representative diagram in FIG. 4. The low-frequency repetitive oscillation command is, for example, a command of a waveform (low-frequency sine wave or the like) shown as a representative diagram in FIG. 5, and has a lower frequency than the repetitive oscillation command represented by the waveform on the right side in FIG. 2. The command obtained by adding the non-repetitive command and the low-frequency repetitive command has, for example, the waveform shown as a representative diagram in FIG. 6 (a waveform obtained by combining the waveforms in FIGS. 4 and 5).

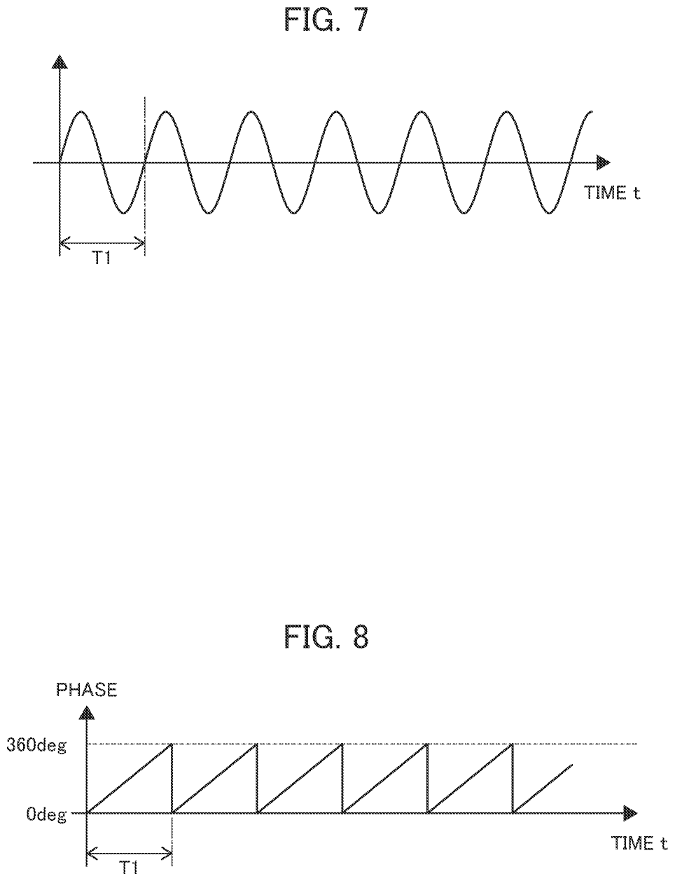

Next, with respect to “generation of phase data”, a method of generating phase data from a repetitive oscillation command will be described with reference to FIGS. 7 to 10. FIG. 7 shows a period T1 in a repetitive oscillation command. The vertical axis represents the command position (distance), and the horizontal axis represents the elapsed time t. In the repetitive oscillation command shown in FIG. 7, the command position returns to the original command position every time the time T1 elapses due to the repetition (reciprocation) of the command and, therefore, it can be recognized that the period thereof is T1.

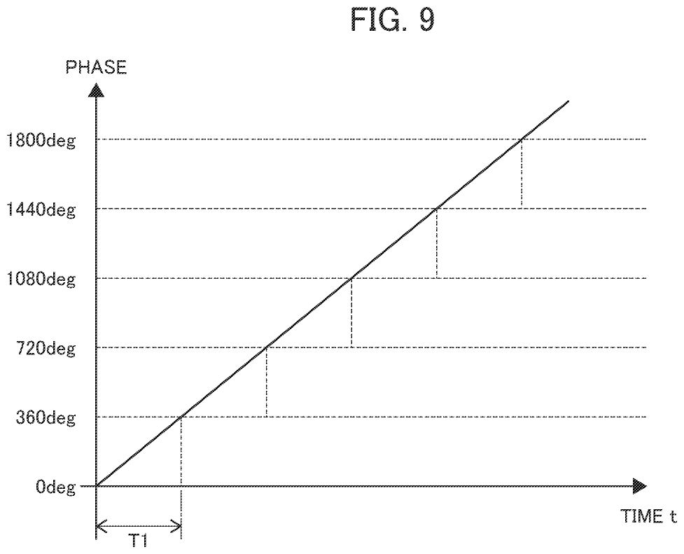

FIG. 8 shows phase data corresponding to the repetitive oscillation command of FIG. 7. The vertical axis represents phase, and the horizontal axis represents elapsed time t. In the phase of the repetitive oscillation command, the constant phase progresses every time a constant time elapses, and the phase returns to the original phase (0°) every time the phase progresses 360° (degrees) after the elapse of the period T1. That is, in the period of the period T1, the phase is proportional to the time t. This state is shown in FIG. 8.

In FIG. 8, the phase returns to the (0°) phase every time the phase progresses by 360° after the elapse of the period T1, but the phase may be further added from 360°. After a time period of the period T1 has elapsed and the phase has progressed by 360°, the phase is added from 360° when the time period has elapsed. In this case, the phase is not limited to within the period of the period T1, but is proportional to the time t in all the periods. This state is shown in FIG. 9. The vertical axis represents phase, and the horizontal axis represents elapsed time t.

In the example of FIG. 9, assuming that the period of a repetitive oscillation command is T1 and the elapsed time is t, the phase θ is represented by the following equation (1) as a mathematical function θ(t) of the time t.

[Formula 1]

θ(t)=360×(t/T1) Equation (1)

Here, assuming that the servo control period in the servo control device 10 is Ts, since the time Ts elapses every one period of the servo control period, the phase θ(t) when one period of the servo control period elapses is obtained by substituting t=Ts, as follows.

[Formula 2]

θ(Ts)=360×(Ts/T1) Equation (2)

When n periods (n=1, 2, 3 . . . ) of the servo control period have elapsed, the phase θ is given as a function θ(n) of the number n of periods as follows.

[Formula 3]

θ(n)=360×(n·Ts/T1) Equation (3)

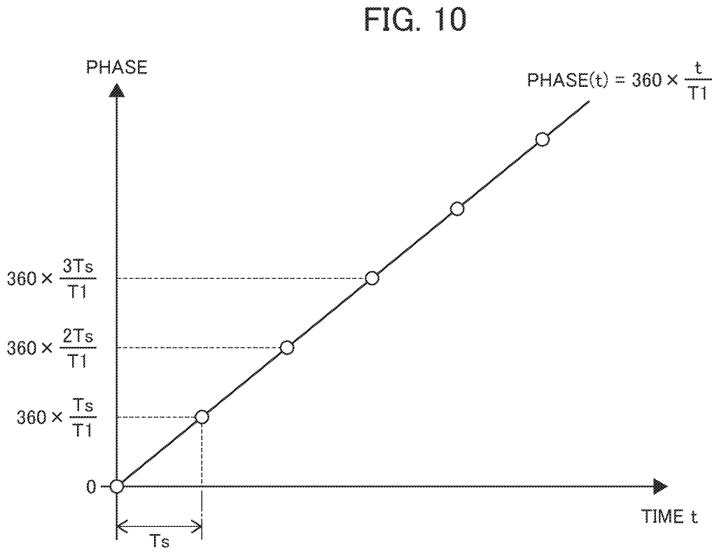

This state is shown in FIG. 10. The vertical axis represents phase, and the horizontal axis represents elapsed time t.

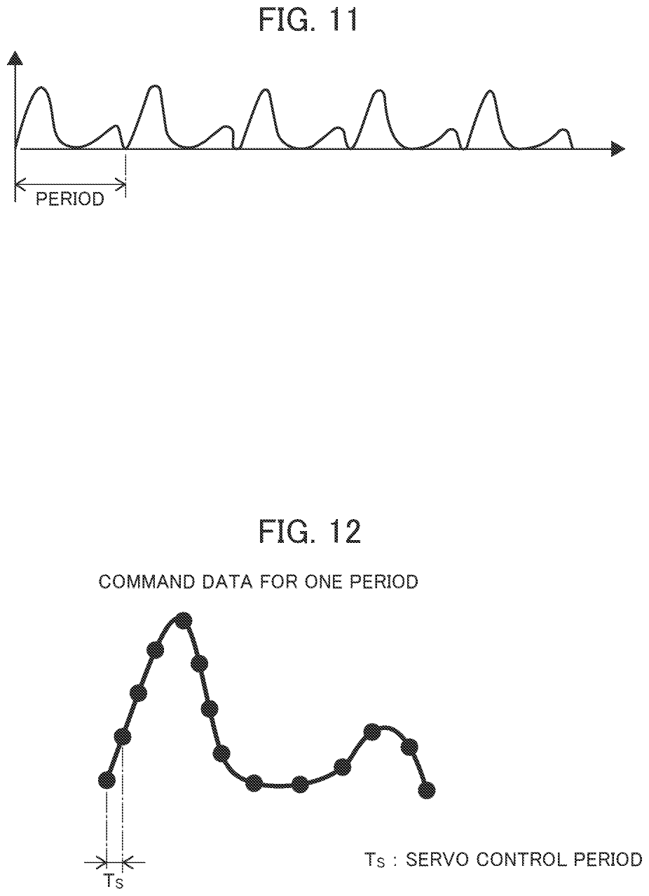

Next, with respect to “generation of a repetitive oscillation command”, a method of obtaining command data for one period for a repetitive oscillation command of a waveform of a free shape which cannot be expressed by only a feature amount such as amplitude will be described with reference to FIGS. 11 and 12. FIG. 11 shows, as an example of a repetitive oscillation command, a command of a waveform of a free shape which cannot be expressed by only a feature amount such as amplitude. FIG. 12 shows the displacement (position) in the wave of the command for each servo period Ts in a manner of dots by extracting only one period of command data from the repetitive oscillation command shown in FIG. 11. The upper control device 20 sends only the command data for one period of FIG. 12 from the repetitive oscillation command of FIG. 11 to the servo control device 10. In order to realize a high-frequency repetitive oscillation command, it is desirable to suppress the communication volume between the upper control device 20 and the servo control device 10 as much as possible and, therefore, data to be transmitted from the upper control device 20 to the servo control device 10 is only command data for one period.

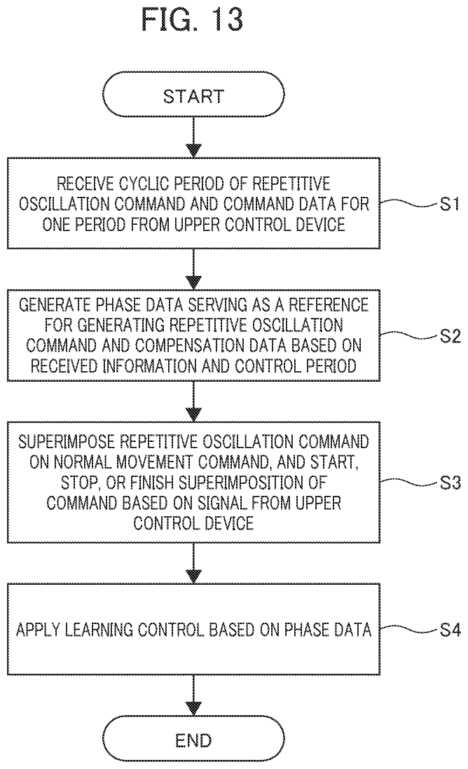

Next, one embodiment of the servo control of the present disclosure will be described with reference to the flowchart of FIG. 13. First, the servo control device receives a cyclic period of a repetitive oscillation command and one period of the command data from a upper control device (Step S1). By receiving the entire data of one period of the repetitive oscillation command, it is possible to deal with a command of a waveform having a free shape which cannot be expressed by only a feature amount.

Next, based on the information received by the servo control device and the control cycle, phase data serving as a reference for the repetitive oscillation command and the compensation data generation is generated (Step S2). The repetitive oscillation command is generated as a command having a repetitive movement as shown in FIG. 11 by connecting each piece of command data for one period of a repetitive oscillation command as shown in FIG. 12. As described above, the phase data is obtained by phase θ(n)=360×(n·Ts/T1) when the period of the received frequency is T1, the servo control periods is Ts, and the number of servo control periods elapsed is n (n=1, 2, 3 . . . ).

Next, the repetitive oscillation command is superimposed on the normal movement command. On the basis of a signal from the upper control device, the superposition of the command is started or stopped or finished (Step S3). Here, as described above, the deviation between the superimposed command obtained by superimposing the repetitive oscillation command on the normal movement command and the signal fed back from the motor is obtained, and the motor is driven and controlled based on the signal with the obtained deviation.

Finally, learning control is applied based on the phase data generated in Step S3 (Step S4), and this flow ends. By applying the learning control, it is possible to enhance the followability corresponding to a superimposed command in which a high-frequency repetitive oscillation command is superimposed on a movement command, and to perform more accurate control.

In the servo control device according to the invention of the present disclosure, with a configuration in which the cyclic period of the repetitive oscillation command and the command data for one period are obtained from the upper control device, it is possible to deal with a case in which a waveform of the repetitive oscillation command is waveform having a free shape which cannot be expressed by only a feature amount. Furthermore, it is possible to form a waveform of a superimposed command of a free shape by superimposing a repetitive oscillation command of a free shape which cannot be expressed by only a feature amount on a basic movement command, whereby an advantageous effect is achieved in that it is possible to deal with a case where further improvement of machining accuracy and machining efficiency is required and finer handling is required.

Furthermore, by applying the learning control, it is possible to realize higher followability and higher accuracy control operation.

Embodiments of the present invention have been described above; however, the present invention is not limited to these embodiments, and it is needless to say that the present invention can be implemented in various forms without departing from the gist of the present invention.

### EXPLANATION OF REFERENCE NUMERALS

10 servo control device
11 repetitive oscillation command/phase data generator
12 learning controller
13 position/speed/current controller
14 first adder
15 second adder
20 upper control device
21 normal movement command
22 repetitive swing command
30 amplifier
40 motor

1. A servo control device for performing control of a servo motor, the servo control device comprising:
a repetitive oscillation command generator that obtains a cyclic period and command data for one period of a repetitive oscillation command waveform, and generates and outputs a repetitive oscillation command; and
a command superimposer that obtains a movement command from the upper control device and superimposes the repetitive oscillation command outputted by the repetitive oscillation command generator on the movement command.

2. The servo control device according to claim 1, wherein the movement command is any one among the command having non-repeatability, a low-frequency repetitive oscillation command, or a command of a combination of the command having non-repeatability and the low-frequency repetitive oscillation command.

3. The servo control device according to claim 1, wherein the repetitive oscillation command generator further includes a phase data generator that generates phase data for each servo control period based on data of the period or frequency of the repetitive oscillation command obtained from the upper control device and the servo control period of the servo control device.

4. The servo control device according to claim 3, further comprising a learning controller that performs learning control based on the phase data generated by the phase data generator.

5. The servo control device according to claim 1, wherein the command superimposer starts, stops, or finishes superimposition of the repetitive oscillation command based on a signal from the upper control device.
